(19) United States
(12) Patent Application Publication
(10) Pub. No.: US 2026/0084670 A1
(43) Pub. Date: Mar. 26, 2026

(54) ELECTROPNEUMATIC ABS BRAKING SYSTEM FOR A COMMERCIAL VEHICLE

(71) Applicant: ZF CV Systems Global GmbH, Bern (CH)

(72) Inventors: Joachim Amtsfeld, Hemmingen (DE); Andre Bork, Hannover (DE); Arne Michaelsen, Seelze (DE); Thomas Pankratz, Barsinghausen (DE); Gerd Roters, Wunstorf (DE)

(21) Appl. No.: 19/405,193

(22) Filed: Dec. 1, 2025

Related U.S. Application Data
(63) Continuation of application No. PCT/EP2024/063142, filed on May 14, 2024.

(30) Foreign Application Priority Data
Jun. 6, 2023 (DE) 10 2023 114 800.1

(51) Int. Cl. B60T 8/26; B60T 7/12; B60T 8/17; B60T 8/171; B60T 8/172; B60T 8/1755; B60T 8/176; B60T 8/58; B60T 13/36; B60T 13/68; B60T 17/22

(52) U.S. Cl. CPC B60T 8/268; B60T 7/12; B60T 8/1701; B60T 8/171; B60T 8/172; B60T 8/17551; B60T 8/176; B60T 8/58; B60T 13/36; B60T 13/683; B60T 17/221; B60T 2240/00; B60T 2270/406; B60T 2270/413

(57) ABSTRACT

An electropneumatic ABS brake system is for a utility vehicle. The brake system has: a foot brake valve operable via a brake pedal and including pneumatic output channels, axle service brake circuits connected to the output channels and each having an axle valve unit and ABS valves for actuating wheel service brakes, a control unit for actuating the ABS valves and the axle valve units, and a first pressure sensor connected to one of the two pneumatic output channels and configured to measure the pneumatic control pressure output by the foot brake valve and to output a first pressure signal to the control unit. A second pressure sensor is provided separately from the first sensor and is configured to output a second pressure signal to the control unit, which receives the two pressure signals and actuates the ABS valves and/or the axle valve units as a function of the signals.

### CROSS-REFERENCE TO RELATED APPLICATIONS

This application is a continuation application of international patent application PCT/EP2024/063142, filed May 14, 2024 designating the United States and claiming priority from German application 10 2023 114 800.1, filed Jun. 6, 2023, and the entire content of both applications is incorporated herein by reference.

### TECHNICAL FIELD

The disclosure relates to an electropneumatic ABS brake system for a utility vehicle, and to a utility vehicle of this kind.

### BACKGROUND

ABS brake systems for utility vehicles generally have a foot brake valve which is operated by the driver via, for example, a brake pedal and has at least two pneumatic, analog output channels, that is, a first pneumatic output channel for the front-axle service brake circuit and a second pneumatic output channel for a rear-axle service brake circuit. The analog brake pressure modulated by the foot brake valve is subsequently supplied to the wheel service brakes via ABS valves of the wheel brake circuits, if appropriate via relay valves for boosting the quantity of air. A respective axle valve unit can preferably be provided in the front-axle service brake circuit and the rear-axle service brake circuit, the axle valve units enabling switchover from the driver brake pressure to supply-air ports in order to subsequently enable autonomous braking via the ABS valves of the wheel brake circuits. Unlike in the case of EBS brake systems, in particular axle modulators are not provided, which, during regular braking processes, generate an analog brake pressure by electrically sensing the driver braking request, including during driver braking operations.

A pressure sensor is often provided for measuring the modulated brake pressure. Here, the pressure sensor can be used to detect the modulated brake pressure and make it available to the electronic control unit, so that the electronic control unit carries out closed-loop pressure control. Furthermore, brake systems are known in which a brake pressure in a trailer service brake circuit is measured.

DE 10 2019 133 011 A1 describes a monostable and fault-tolerant parking brake valve arrangement for an electronically controllable pneumatic brake system of a utility vehicle, in which parking brakes are actuated via a shuttle valve, wherein a pressure sensor is provided upstream of each of the electropneumatic parking brake valves at the ports of the shuttle valve, and the pressure sensors output their measurement signals to different ECUs.

DE 10 2017 005 979 A1 describes an electropneumatic control module for an electronically controllable pneumatic brake system of a vehicle train composed of a towing vehicle and a trailer vehicle, in which a trailer control valve unit having one or more electropneumatic valves and a parking brake unit are provided, wherein the parking brake unit has a spring-type actuator port for a spring-type actuator for the towing vehicle and has a parking brake valve unit. Here, provision is made for an electropneumatic control module to have a redundant pressure sensor which is arranged on a first redundancy pressure line or at a redundancy pressure port and is configured to detect the pneumatic redundancy pressure at the redundancy pressure port or in the first redundancy pressure line and to provide a corresponding redundancy pressure signal as a brake representation signal, which represents a driver request which is compared with a service brake signal received from a central module or a further control unit.

The use of pressure sensors is thus known in parking brake systems of this kind.

### SUMMARY

It is an object of the disclosure to provide an electropneumatic ABS brake system for a utility vehicle which enables reliable brake control with relatively little outlay.

This object is achieved by an electropneumatic ABS brake system according to various embodiments of the disclosure. The disclosure also provides a utility vehicle having this brake system, a vehicle combination composed of a utility vehicle and a trailer vehicle, and a method for operating the electropneumatic ABS brake system.

A brake system with electropneumatic axle valve units and ABS valves, which are actuated by an electronic control unit or ECU, is thus created. Electropneumatic brake systems of this kind are also referred to as ABS brake systems. Here, according to the disclosure, a first pressure sensor and a second pressure sensor are provided at different points in the brake system, wherein the pressure sensors output their pressure signals to the electronic control unit, that is, the ECU. The ECU receives the two pressure signals and can carry out different processes based on the pressure signals.

As a result, some advantages are already achieved:

The brake system according to the disclosure can be configured with little outlay; therefore, only two pressure sensors are provided, that is, in comparison to known service brake systems, only one further pressure sensor, for example. It is therefore in particular not necessary to form a digital foot brake module; the first pressure sensor can directly measure the brake pressure modulated by the foot brake valve and thus determine the driver braking request or the driver brake pedal operation.

Therefore, the pressure values indicated by the pressure signals of the two sensors can be compared; as a result of the comparison, several processes are already possible, in particular with two sensors which can measure comparable values in certain situations and can thus be checked for plausibility with respect to each other.

A further advantage is that this system can be retrofitted by way of, for example, the second pressure sensor or one of the two pressure sensors being subsequently connected as an external pressure sensor, and the electronic control unit being programmed accordingly. Therefore, little additional effort is required for the modification. Updates can also be carried out with little effort.

Furthermore, existing brake system concepts can be readily extended, that is, in particular by receiving the further pressure sensor, as a result of which the functional reliability can be increased.

According to a preferred embodiment, the pressure values indicated by the pressure signals are compared; as a result of the comparison, several processes are already possible, in particular:
to assess the functionality of the two pressure sensors, for example by assessing the difference between the pressure values or the behavior of the pressure values over time, so that, for example, faults, defects or failure of a sensor can be identified, so that, in particular, a plausibility check is rendered possible, and/or
to calibrate the pressure signals of the two pressure sensors, for example in order to establish and set common minimum and/or maximum values, and/or
to determine a different braking behavior of the service brakes and service brakes on the axles; this can be attributed to different braking behavior, for example on account of the axle loads or the coefficient of friction conditions,
and/or to actuate the axle valve units and/or the ABS valves.

Here, in brake-free phases, zero values of the pressure signals can be determined and compared, in particular for calibration and/or determining faults.

Further steps can be carried out in driver-induced and/or autonomous brake operations, that is, during braking operations. Here, the braking behavior can be determined on the basis of the absolute values, relative values and/or changes over time, in particular via the difference between the pressure values.

Unlike in the case of EBS brake systems, the two axle valve units are provided for overriding the analog driver braking during normal operation in the case of driver braking; EBS systems, by contrast, provide sensing of the driver request via a sensor and pneumatic modulation at the wheel brakes using a supply pressure via proportional valves during normal operation, so that the driver brake pressure is pneumatically overridden only as a redundancy path in the case of EBS systems.

The first and the second axle are, in particular, a front axle and a rear axle of the utility vehicle. Here, it is also possible to realize utility vehicles having several axles, for example three axles, on which, in particular, six ABS valves are thus provided.

According to an embodiment, the brake system has a trailer service brake circuit, which is connected in particular to a front-axle service brake circuit and/or a rear-axle service brake circuit, in particular downstream of the respective axle valve unit. A trailer ABS valve, which is actuated by the electronic control unit, in particular for regulating or setting the trailer brake pressure, and furthermore a trailer control valve, that is, TCV, which generally also receives the supply pressure, and a first coupling head for outputting the analog control pressure, in particular the driver brake pressure, to the trailer, and a further coupling head for outputting the supply pressure to the trailer are then provided in the trailer brake circuit. In addition, an electrical and/or electronic interface can be provided. The trailer ABS valve is thus actuated by the ECU for modulating the trailer brake pressure, which is subsequently output via the trailer control valve and the coupling head as pneumatic control pressure to a connected trailer brake system. The second pressure sensor is preferably arranged in the trailer service brake circuit in order to measure the trailer brake pressure and output it to the electronic control unit. As a result, the electronic control unit can firstly carry out closed-loop pressure control or closed-loop control of the trailer service brake circuit, that is, by measuring the modulated brake pressure and actuating the trailer ABS valve. The trailer brake pressure can be set very accurately by the closed-loop control or closed-loop pressure control, in particular its dynamic behavior can be set more effectively, as a result of which reliability is increased.

Furthermore or as an alternative to this, trailer detection can be performed, in the case of which the pressure signal is used to determine whether a trailer, by way of its trailer brake system, is connected to the coupling head. It is thus possible to infer the presence of a connected trailer brake system from the dynamic behavior of the measured pressure value; it is thus possible to infer, for example, from slower behavior in the event of changes in the pressure value that a trailer is connected.

The second pressure sensor can be arranged, for example, between the trailer ABS valve and the trailer control valve; in this way, in particular dynamic or rapid closed-loop control of the trailer brake pressure is achieved since the pressure is measured directly downstream of the actuating unit. Furthermore, the second pressure sensor can be arranged between the trailer control valve and the coupling head; here, the closed-loop control may be somewhat delayed; however, the functioning of the trailer detection is improved here since the brake pressure measured downstream of the trailer control valve depends directly on whether a connected trailer brake system consumes compressed air.

According to a further embodiment, the second pressure sensor is connected directly to that pneumatic output channel of the foot brake module to which the first pressure sensor is not connected. A configuration of this kind can be provided in particular in a brake system without a trailer service brake circuit, but also in brake systems with a trailer service brake circuit. Therefore, the pressure in both output channels is measured, so that these values can be directly compared with each other, in particular for checking plausibility or identifying faults and/or calibration. Furthermore, however, the braking behavior of the two axle service brake circuits can also be determined. Therefore, the different compressed-air consumption at the axles in the case of strong brake operations can be detected.

The pressure sensors can preferably be of identical or uniform configuration, so that the range of parts is limited, the costs are kept low and directly comparable pressure signals are output. The pressure sensors can be integrated, for example, in the foot brake module, and/or can be fitted subsequently as external sensors. This allows, in particular, a high degree of flexibility and retrofitability. Furthermore, it is also possible for more than two, in particular three, pressure sensors to be provided, for example by way of retrofitting one or two pressure sensors, for example for combined arrangement at the two pneumatic output channels and additionally in the trailer service brake circuit.

Consequently, a utility vehicle having a brake system of this kind is also created, as is furthermore a vehicle combination with the connected trailer.

### BRIEF DESCRIPTION OF DRAWINGS

The invention will now be described with reference to the drawings wherein:

FIG. 1 shows an electropneumatic circuit diagram of a brake system according to one embodiment of the disclosure having a pressure sensor arranged in the trailer service brake circuit;

FIG. 2 shows a further embodiment of a brake system having a pressure sensor connected upstream of the coupling head in the trailer brake circuit; and,

FIG. 3 shows an embodiment of a brake system without a trailer service brake circuit.

### DETAILED DESCRIPTION

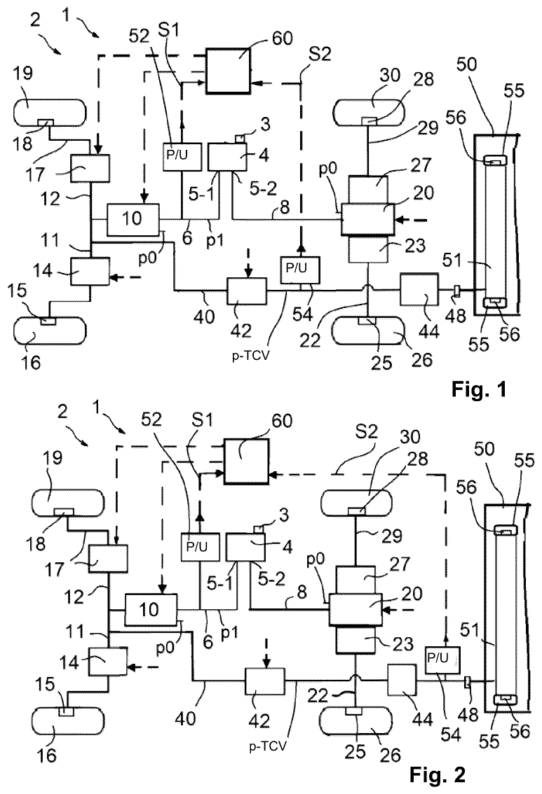

FIG. 1 shows an electropneumatic ABS service brake system 1. It is formed in a utility vehicle 2 indicated here, for example a truck, and has a brake pedal 3 with a foot brake valve 4 and two pneumatic output channels 5-1, 5-2 of the foot brake valve 4. A front-axle service brake circuit 6 and a rear-axle service brake circuit 8 are connected to the pneumatic output channels 5-1 and 5-2, so that they are supplied with an analog compressed-air brake signal in parallel by the foot brake valve 4. A front-axle valve unit 10 is provided in the front-axle service brake circuit 6 and is directly connected to the first pneumatic output channel 5-1. A left front-wheel service brake circuit 11 having a left front ABS valve 14 and a left front-wheel service brake 15 for the left front wheel 16 and correspondingly a right front-wheel service brake circuit 12 having a right front ABS valve 17 and a right front-wheel service brake 18 for braking the right front wheel 19 are in turn connected to the front-axle valve unit 6. The rear axle is correspondingly formed with a rear-axle valve unit 20, which is connected to the second pneumatic output channel 5-2 of the foot brake valve 4, and with rear-wheel service brake circuits 22 and 29 which are connected to the rear-axle valve unit 20 and in which the rear wheel service brakes are each connected via an ABS valve 23 and 27, that is, a left rear-wheel service brake 25 of the left rear wheel 26 is connected in the left rear-wheel service brake circuit 22 via a left rear ABS valve 23, and correspondingly a right rear-wheel service brake 28 of the right rear wheel 30 is connected in the right rear-wheel service brake circuit 29 via a right rear ABS valve 27. An additionally provided parking brake system is not shown here.

In the embodiments of FIGS. 1 and 2, a trailer service brake circuit 40 is additionally provided, which is connected, for example, to the front-axle service brake circuit 6, here downstream of the front-axle valve unit 10. In principle, the trailer service brake circuit 40 can also be connected to the rear-axle service brake circuit 8; furthermore, a valve device can be provided in a customary manner, which valve device enables pneumatic supply of the trailer service brake circuit 40 from both the front-axle service brake circuit 6 and the rear-axle service brake circuit 8. A trailer ABS valve 42 is in turn provided in the trailer service brake circuit 40, the pneumatic coupling head 48 provided for the control pressure being connected via a trailer control valve, that is, TCV 44, to the trailer ABS valve for connection of a trailer 50, indicated here, by way of a trailer brake system 51. Trailer wheels 55, which are braked by trailer-wheel service brakes 56 of the trailer brake system 51, are therefore provided in the trailer 50 in a customary manner. For the sake of simplicity, only one trailer axle is shown here, but several trailer axles can be provided in particular. The pneumatic trailer control pressure p-TCV in the trailer service brake circuit 40 is thus modulated via the electrically actuated trailer ABS valve 42 and output to the trailer 50 in a customary manner via the trailer control valve TCV 44 and the coupling head 48. In addition, a further coupling head is generally provided for the supply pressure.

A first pressure sensor 52, which measures the pneumatic pressure p1 and outputs a first pressure signal S1, is connected in the front-axle service brake circuit 6. In the embodiment of FIG. 1, a second pressure sensor 54 is provided between the trailer ABS valve 42 and the trailer control valve 44, which here measures the pneumatic pressure p-TCV and outputs a second pressure signal S2.

An electronic control unit ECU 60 receives the two pressure signals S1 and S2; furthermore, it generally also receives wheel rotation speed signals of the wheels 16, 19, 26, 30; furthermore, the ECU 60 actuates the axle valve units 10 and 20, and advantageously also the ABS valves 14, 17, 23, 27 for closed-loop ABS control. The axle valve units 10 and 20 receive the analog pneumatic control pressure provided at the two output channels 5-1 and 5-2 via the foot brake valve 4 and conduct it to the wheel service brake circuits 11, 12 and 22, 29, respectively. Furthermore, in the case of a brake system 1 with an autonomous braking function, autonomous braking operations, for example for autonomous stability interventions, can also be carried out by the ECU 60 by way of the axle valve units 10 and 20 conducting, instead of the pneumatic control pressure which is provided via the output channels 5-1, 5-2, a supply pressure p0 which is then subsequently regulated by the ECU 60 via the ABS valves 14, 17, 23, 27. As a result, the autonomous braking functions—known from ABS brake systems of this kind—are possible, even without an EBS system, in which the pneumatic output channels 5-1, 5-2 serve merely for redundant fallback levels.

In the embodiment of FIG. 1, the first pressure sensor 52 is therefore provided directly at the first pneumatic output channel 5-1 and thus directly measures the brake pressure p1 modulated by the driver via the brake pedal 3, converts it into the first pressure signal S1 and outputs it to the ECU 60, which thus directly detects the brake request of the driver, even without a digital output channel of the foot brake valve 4. Here, the first pressure sensor 52 can be connected as an external pressure sensor to the front-axle service brake circuit 6, or else can be integrated in the foot brake valve 4. A digital value of the brake operation is made directly available to the ECU 60 by the first brake signal S1. The second pressure sensor 54 measures the trailer brake pressure p-TCV downstream of the trailer ABS valve 42, the trailer brake pressure thus being set by the ECU 60 as a function of the actuation of the trailer ABS valve 42. Therefore, direct closed-loop control is possible, in the case of which the ECU 60 actuates the trailer ABS valve 42 and directly measures the trailer brake pressure p-TCV generated as a result.

Furthermore, a redundancy or checking possibility is rendered possible, in the case of which the ECU 60, in brake-free phases in which neither the brake pedal 3 is operated nor autonomous braking operations are input via the front-axle valve unit 10, can compare the zero values of the brake pressures p1 and p-TCV via the pressure signals S1 and S2. In these phases, the pressures p1 and p-TCV should fundamentally correspond, possibly with a corresponding pressure drop in the lines. Therefore, comparison or calibration can be performed here, including in order to, for example, calibrate the trailer pressure p-TCV with respect to the brake pressure p1, and to detect faults in one of the pressure sensors 52 and 54.

In the embodiment of FIG. 2, with an otherwise unchanged configuration, the second pressure sensor 54 is likewise provided in the trailer service brake circuit 40, but between the trailer control valve 44 and the coupling head 48. Therefore, it is also possible here, in principle, to measure the trailer pressure p-TCV output via the coupling head 48. Here, the closed-loop control by the ECU 60 via actuation of the trailer ABS valve 42 may be somewhat more indirect since the pressure is not measured directly downstream of the trailer ABS valve 42; for this purpose, however, the second pressure sensor 54 according to FIG. 2 allows better trailer detection: If the brake system of the trailer 50 is connected to the coupling head 48, the dynamic behavior of the brake pressure value at the coupling head 48 changes. Therefore, pressure values output or provided in particular via the trailer control valve 44 can be passed on less dynamically when a trailer 50 is connected. Changes in the pressure value at the coupling head 48 or at the output of the trailer control valve 44 are thereby generally reproduced more slowly, that is, with a time delay for example. In the case of compressed-air consumption at the trailer 50, the pressure value at the second pressure sensor 54 thus also drops for a short time, and this is correspondingly detected and can be associated with the presence of the trailer 50. Trailer detection of this kind is also possible in the embodiment of FIG. 1.

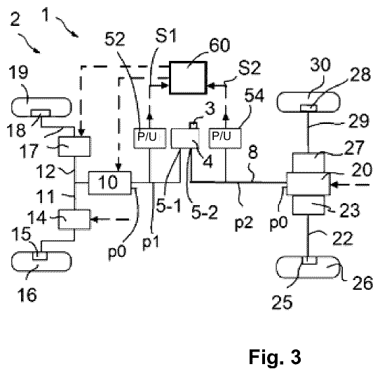

The embodiment of FIG. 3 describes an electropneumatic brake system 1 of a utility vehicle 2 without a trailer service brake circuit 40. With an otherwise unchanged configuration compared to FIGS. 1 and 2, the second pressure sensor 54 is connected here to the second pneumatic output channel 5-2, that is, to the rear-axle service brake circuit 8, measures the brake pressure p2 provided there and outputs the second pressure signal S2 to the ECU 60. A redundancy check is therefore rendered possible here, in the case of which the two pressure signals S1 and S2 can be directly compared with each other. In the absence of brake operation or generally in the case of braking operations, firstly identical brake pressures p1 and p2 or brake pressures should be measured in the ratio which is pneumatically represented in the characteristic curves of the foot brake valve; in the case of different pressure consumption in the front-axle service brake circuit 6 and rear-axle service brake circuit 8, correspondingly dynamically different or slightly deviating values may occur, with the result that, for example, the brake pressure p1 or p2 in the brake circuit 6 or 8 at which the pressure consumption is greater drops somewhat. Fitting the second pressure sensor 54 at the second pneumatic output channel 5-2 in this way is also possible in the embodiment of FIGS. 1 and 2.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Electropneumatic ABS brake system
2 Utility vehicle
3 Brake pedal
4 Foot brake valve
5-1 First pneumatic output channel of the foot brake valve 4
5-2 Second pneumatic output channel of the foot brake valve 4
6 Front-axle service brake circuit
8 Rear-axle service brake circuit
10 Front-axle valve unit
11 Left front-wheel brake line
12 Right front-wheel brake line
14 Left front ABS valve
15 Left front-wheel brake
16 Left front wheel
17 Right front ABS valve
18 Right front-wheel brake
19 Right front wheel
20 Rear-axle valve unit
22 Left rear-wheel service brake circuit
23 Left rear ABS valve
25 Left rear-wheel brake
26 Left rear wheel
27 Right rear ABS valve
28 Right rear-wheel brake
29 Right rear-wheel service brake circuit
30 Right rear wheel
40 Trailer service brake circuit in the utility vehicle 2
42 Trailer ABS valve
44 Trailer control valve (TCV)
48 Pneumatic coupling head
50 Trailer
51 Trailer brake system in the trailer 50, connected to the trailer service brake circuit 40 of the utility vehicle 2
52 First pressure sensor
54 Second pressure sensor
55 Trailer wheel
56 Trailer-wheel service brake
60 Electronic control unit (ECU)
p0 Supply pressure
p1 Driver brake pressure at the first pneumatic output channel 5-1
p2 Driver brake pressure at the second pneumatic output channel 5-2
p-TCV Trailer brake pressure
S1 First pressure signal
S2 Second pressure signal

1. An electropneumatic ABS brake system for a utility vehicle, the electropneumatic ABS brake system comprising:
a foot brake valve configured to be operated via a brake pedal and having a first pneumatic output channel and a second pneumatic output channel;
a first axle service brake circuit connected to said first pneumatic output channel and having a first axle valve unit and at least one first ABS service brake circuit connected to said first axle valve unit, said at least one first ABS service brake circuit having a first ABS valve for actuating at least one first wheel service brake arranged therein;
a second axle service brake circuit connected to said second pneumatic output channel and having a second axle valve unit and at least one second ABS service brake circuit connected to said second axle valve unit, said at least one second ABS service brake circuit having a second ABS valve for actuating at least one second wheel service brake arranged therein;
an electronic control unit for actuating said first ABS valve and said second ABS valve, said first axle valve unit and said second axle valve unit;
a first pressure sensor connected to one of said first pneumatic output channel and said second pneumatic output channel and configured to measure a pneumatic control pressure output by said foot brake valve and to output a first pressure signal to said electronic control unit;
a second pressure sensor provided separately from said first pressure sensor;
said second pressure sensor being configured to output a second pressure signal to said electronic control unit; and,
said electronic control unit being configured to receive the two pressure signals and, as a function of the two pressure signals, to actuate at least one of said first ABS valve and said second ABS valve and/or at least one of said first axle valve unit and said second axle valve unit.

2. The electropneumatic ABS brake system of claim 1, wherein, in an event of driver braking by operation of the brake pedal, analog brake pressure output via said foot brake valve to said first pneumatic output channel and said second pneumatic output channel is respectively conducted by said first axle valve unit and said second axle valve unit to said first ABS service brake circuit and said second ABS service brake circuit.

3. The electropneumatic ABS brake system of claim 1, wherein:
said electronic control unit is configured to compare the two pressure signals with each other and from the comparison at least one of:
assess the functionality of the two pressure sensors;
calibrate the pressure signals of the two pressure sensors;
determine a different braking behavior of the at least one first wheel service brake and the at least one second wheel service brake; and,
actuate said first axle valve unit and said second axle valve unit and/or said first ABS valve and said second ABS valve.

4. The electropneumatic ABS brake system of claim 3, wherein, in brake-free phases, said electronic control unit receives zero values of the pressure signals and compares them with each other.

5. The electropneumatic ABS brake system of claim 1, wherein the electronic control unit, during at least one of an autonomous brake operation and a driver-induced brake operation, carries out at least one of:
measuring absolute values, relative values and/or changes in pressure values of the two pressure signals over time;
forming a difference between the measured pressure values of the two pressure signals; and,
determining changes in a ratio and/or a difference between the pressure values of the two pressure signals over time.

6. The electropneumatic ABS brake system of claim 1, wherein said electronic control unit is further configured to carry out, by measuring wheel rotation speeds and actuating the first ABS valve and the second ABS valve, closed-loop brake slip control.

7. The electropneumatic ABS brake system of claim 1, wherein said electronic control unit is further configured to carry out, by measuring wheel rotation speeds and actuating the first ABS valve and the second ABS valve, closed-loop brake slip control without actuating the axle valve units.

8. The electropneumatic ABS brake system of claim 1, wherein:
at least one of said first axle valve unit and said second axle valve unit has a supply pressure port for receiving supply pressure; and,
said electronic control unit is configured to carry out autonomous operation of the wheel service brakes by actuating at least one of:
said first axle valve unit for conducting the supply pressure to said at least one first ABS service brake circuit;
said second axle valve unit for conducting the supply pressure to said at least one second ABS service brake circuit; and,
said first ABS valve and said second ABS valve for modulating brake pressures delivered to the wheel service brakes.

9. The electropneumatic ABS brake system of claim 1, wherein:
at least one of said first axle valve unit and said second axle valve unit has a supply pressure port for receiving supply pressure; and,
said electronic control unit is configured to carry out autonomous operation of the wheel service brakes, as at least one of an autonomous braking process and a stability control, by actuating at least one of:
said first axle valve unit for conducting the supply pressure to said at least one first ABS service brake circuit;
said second axle valve unit for conducting the supply pressure to said at least one second ABS service brake circuit; and,
said first ABS valve and said second ABS valve for modulating brake pressures delivered to the wheel service brakes.

10. The electropneumatic ABS brake system of claim 1, wherein said first axle service brake circuit is a front-axle service brake circuit and said second axle service brake circuit is a rear-axle service brake circuit.

11. The electropneumatic ABS brake system of claim 1 further comprising:
a trailer service brake circuit connected to at least one of said first axle service brake circuit and said second axle service brake circuit;
said trailer service brake circuit including a trailer ABS valve which is connected to at least one of said first axle service brake circuit and said second axle service brake circuit and is configured to be actuated by said electronic control unit for inputting a trailer brake pressure;
said trailer service brake circuit further including a trailer control valve and a coupling head for connection of a trailer brake system of a trailer; and,
wherein said second pressure sensor is provided:
between said trailer ABS valve and said trailer control valve, or
between said trailer control valve and said coupling head.

12. The electropneumatic ABS brake system of claim 11, wherein said trailer service brake circuit is connected to at least one of said first axle service brake circuit and said second axle service brake circuit downstream of corresponding ones of said first axle valve unit and said second axle valve unit.

13. The electropneumatic ABS brake system of claim 11, wherein said electronic control unit is configured to carry out closed-loop brake control by receiving the second pressure signal and actuating said trailer ABS valve, as a closed control loop for modulating the trailer brake pressure.

14. The electropneumatic ABS brake system of claim 11, wherein said electronic control unit is configured to carry out trailer detection by way of the electronic control unit detecting whether the trailer brake system of the trailer is connected to said coupling head from at least one of:
the second pressure signal;
changes in the second pressure signal over time;
a comparison of the two pressure signals; and,
a comparison of the changes in the two pressure signals over time.

15. The electropneumatic ABS brake system of claim 1, wherein:
said second pressure sensor is connected to one of said first pneumatic output channel and said second pneumatic output channel to which said first pressure sensor is not connected;
said electronic control unit, from at least one of a comparison of the two pressure signals and a comparison of changes in the two pressure signals over time, is configured to at least one of:
carry out redundancy determination;
infer faults in one of said first pressure sensor and said second pressure sensor or the foot brake valve; and,
measure different compressed-air consumption levels of said first axle service brake circuit and said second axle service brake circuit.

16. The electropneumatic ABS brake system of claim 1, wherein one or both of said first pressure sensor and said second pressure sensor are integrated in one component or two components of a following group:
in said foot brake valve, said the trailer control valve, and at least one of said first axle valve unit and said second axle valve unit.

17. The electropneumatic ABS brake system of claim 1, wherein at least one of said first pressure sensor and said second pressure sensor are connected to at least one of said first ABS service brake circuit and said second ABS service brake circuit.

18. A utility vehicle comprising:
a brake pedal;
an electropneumatic ABS brake system including a foot brake valve, a first axle service brake circuit, a second axle service brake circuit, an electronic control unit, a first pressure sensor, and a second pressure sensor;
said foot brake valve being configured to be operated via said brake pedal and having a first pneumatic output channel and a second pneumatic output channel;
said first axle service brake circuit being connected to said first pneumatic output channel and having a first axle valve unit and at least one first ABS service brake circuit connected to said first axle valve unit, said at least one first ABS service brake circuit having a first ABS valve for actuating at least one first wheel service brake arranged therein;
said second axle service brake circuit being connected to said second pneumatic output channel and having a second axle valve unit and at least one second ABS service brake circuit connected to said second axle valve unit, said at least one second ABS service brake circuit having a second ABS valve for actuating at least one second wheel service brake arranged therein;
said electronic control unit being for actuating said first ABS valve and said second ABS valve, said first axle valve unit and said second axle valve unit;
said first pressure sensor being connected to one of said first pneumatic output channel and said second pneumatic output channel and configured to measure a pneumatic control pressure output by said foot brake valve and to output a first pressure signal to said electronic control unit;
said second pressure sensor being provided separately from said first pressure sensor;
said second pressure sensor being configured to output a second pressure signal to said electronic control unit; and,
said electronic control unit being configured to receive the two pressure signals and, as a function of the two pressure signals, to actuate at least one of said first ABS valve and said second ABS valve and/or at least one of said first axle valve unit and said second axle valve unit.

19. A vehicle combination comprising the utility vehicle of claim 18 and a trailer configured to be connected to said utility vehicle.

20. A method for operating an electropneumatic ABS brake system including a foot brake valve, a first axle service brake circuit, a second axle service brake circuit, an electronic control unit, a first pressure sensor, and a second pressure sensor; the foot brake valve being configured to be operated via the brake pedal and having a first pneumatic output channel and a second pneumatic output channel; the first axle service brake circuit being connected to the first pneumatic output channel and having a first axle valve unit and at least one first ABS service brake circuit connected to the first axle valve unit, the at least one first ABS service brake circuit having a first ABS valve for actuating at least one first wheel service brake arranged therein; the second axle service brake circuit being connected to the second pneumatic output channel and having a second axle valve unit and at least one second ABS service brake circuit connected to the second axle valve unit, the at least one second ABS service brake circuit having a second ABS valve for actuating at least one second wheel service brake arranged therein; the electronic control unit being for actuating the first ABS valve and the second ABS valve, the first axle valve unit and the second axle valve unit; the first pressure sensor being connected to one of the first pneumatic output channel and the second pneumatic output channel and configured to measure a pneumatic control pressure output by the foot brake valve and to output a first pressure signal to the electronic control unit; the second pressure sensor being provided separately from the first pressure sensor; the second pressure sensor being configured to output a second pressure signal to the electronic control unit; and, the electronic control unit being configured to receive the two pressure signals and, as a function of the two pressure signals, to actuate at least one of the first ABS valve and the second ABS valve and/or at least one of the first axle valve unit and the second axle valve unit; the first pressure sensor and the second pressure sensor each being configured to measure a current pressure value and output the two pressure signals to the electronic control unit; the method comprising at least one of:
performing a redundancy determination or comparison determination via the electronic control unit, in which the electronic control unit checks whether faults exist in at least one of the two pressure sensors;
controlling pressure in a closed-loop manner in a trailer service brake circuit via the electronic control unit, by receiving the second pressure signal and actuating a trailer ABS valve;
evaluating different compressed-air consumption levels in the ABS service brake circuits via the electronic control unit, for assessing a braking behavior of a utility vehicle; and,
detecting whether a trailer brake system of a trailer is connected to a coupling head.
